(19) United States
(12) Patent Application Publication
(10) Pub. No.: US 2005/0198809 A1
(43) Pub. Date: Sep. 15, 2005

(54) Working system of metallic wire rod

(76) Inventor: Takashi Fujii, Tokyo (JP)

Correspondence Address: REED SMITH LLP, 3110 Fairview Park Drive, Suite 1400, Falls Church, VA, 22042, US

(21) Appl. No.: 10/796,202

(22) Filed: Mar. 10, 2004

(51) Int. Cl. B23P 23/00

(52) U.S. Cl. 29/564.6

(57) ABSTRACT

In a series of working processes of working a metallic wire rod (a) in a coiled condition to a wire rod which is under predetermined conditions, this system comprises: the step of delivering the coiled wire rod at a constant speed thereby to bring the wire rod into a linear condition (a bar) (1); the step of straightening the wire rod into a straight condition by causing the wire rod to pass through a straightening device in one or more places arranged in the direction of travel of the delivered wire rod (2); the step of causing the straightened wire rod to travel in a correct position, judging whether outside diameters and surface defects of the straightened wire rod are within preset prescribed allowances by detecting the outside diameters and surface defects, and outputting and storing results of the detection and judgment (3); and the step of cutting the wire rod in a traveling condition to preset predetermined lengths and delivering the cut wire rod to a mechanism for sorting the cut wire rod according to the quality of the cut wire rod (4).

### BACKGROUND OF THE INVENTION

1. Field of the Invention

The present invention relates to a working system for a series of working processes which forms a correct wire rod (bar) within preset standard values from a relatively fine metallic wire rod.

2. Description of the Related Art

A large number of individual devices, such as straightening devices which straighten a coiled wire rod in a straight condition, devices which measure the outside diameter and length of a wire rod and devices which cut a wire rod to definite lengths, have so far been known.

Although for example, a Japanese patent publication gazette (Japanese Patent Publication No. 6-85951) describes “a continuous working method and a continuous bending apparatus for the cutting and bending of a long material,” this only means that the bending and cutting of a long material are performed by use of a single continuous apparatus.

As described above, a system which can perform the steps of working a wire rod in a coiled condition to a wire rod (bar) within preset correct tolerances in a single process by use of conventional means has not yet been supplied.

Therefore, the object of the present invention is to ensure that the steps of producing a bar material within correct tolerances from a wire rod in a coiled condition can be performed by use of a single continuous apparatus.

### SUMMARY OF THE INVENTION

In the present invention, there is provided a working system of a metallic wire rod in a series of working processes of working a metallic wire rod (bar) in a coiled condition to a wire rod which is under predetermined conditions, which comprises: the step of delivering the coiled wire rod at a constant speed thereby to bring the wire rod into a linear condition (a bar); the step of straightening the wire rod into a straight condition by causing the wire rod to pass through a straightening device in one or more places arranged in the direction of travel of the delivered wire rod; the step of causing the straightened wire rod to travel in a correct position, judging whether outside diameters and surface defects of the straightened wire rod are within preset prescribed allowances by detecting the outside diameters and surface defects, and outputting and storing results of the detection and judgment; and the step of cutting the wire rod in a traveling condition to preset predetermined lengths and delivering the cut wire rod to a mechanism for sorting the cut wire rod according to the quality of the cut wire rod. The working system has the sorting function of rejecting the delivered wire rod (bar) if the wire rod (bar) has defects outside the above-described tolerances for defects.

Concretely, a feature of the present invention resides in that in working a wire rod (bar) of a given size from a coiled wire rod, a mixed oil comprising a cutting oil and a lubricating oil is sprayed or applied to the wire rod as a flushing oil in order to make smooth the straightening step for bringing the wire rod into a straight condition by washing the surface of the wire rod, thereby to polish the surface a little and obtain a luster.

Concretely, a feature of the present invention resides in that it is ensured that in a series of continuous working steps by use of a single apparatus, whether the outside diameter of the wire rod is within preset tolerances is judged and that signals of pass/fail results are output.

Concretely, a feature of the present invention resides in that it is ensured that in a series of continuous working steps by use of a single apparatus, whether defects such as surface damage, dents and exfoliations are present is measured, that whether the defects are within preset tolerances, and that signals of pass/fail results are output.

Concretely, a feature of the present invention resides in that it is ensured that in a series of continuous working steps by use of a single apparatus, the length of the wire rod is measured, that whether the length is within preset tolerances, and that signals of pass/fail results are output.

A further feature of the present invention resides in that it is ensured that the work of cutting the wire rod (bar) to given lengths can be performed while the wire rod (bar) is in a moving condition. As a result of this, troublesome means which might temporarily stop the flow of the wire rod (bar) and time losses and uncut surfaces due to such means are eliminated and it is ensured that the work can be performed, with a smooth flow of the work kept as it is.

Concretely, a feature of the present invention resides in that it is ensured that if even anyone of the above-described factors of outside diameter, surface defects and length of the wire rod (bar) is outside the tolerances, that is, even if the wire rod (bar) is a nonconforming product, the nonconforming product can be distinguished from a conforming product and housed in housing cases provided for each of the respective factors.

Furthermore, the present invention has other objects of the invention, other excellent features and actions and effects of the invention, which will become apparent in the descriptions of the following embodiments.

### BRIEF DESCRIPTION OF THE DRAWINGS

FIG. 1 is a front view to explain a series of steps in an embodiment of the present invention;

FIG. 2 is a plan view of FIG. 1;

FIG. 3 is a side view of FIG. 1;

FIG. 4 is an explanatory diagram of wire rod delivering;

FIG. 5 is an explanatory diagram of flushing oil supply;

FIG. 6 is an explanatory diagram of a straightening mechanism;

FIG. 7 is an explanatory diagram of a straightening mechanism and outside diameter measurement;

FIG. 8 is a plan view to explain wire rod surface measurement;

FIG. 9 is a front view to explain wire rod surface measurement;

FIG. 10 is an explanatory diagram of a display screen of a computer;

FIG. 11 is an explanatory diagram of cutting and transfer of a wire rod;

FIG. 12 is a side view to explain a sorting mechanism;

FIG. 13 is a side view to explain a sorting mechanism; and

FIG. 14 is a block diagram to explain a series of work steps.

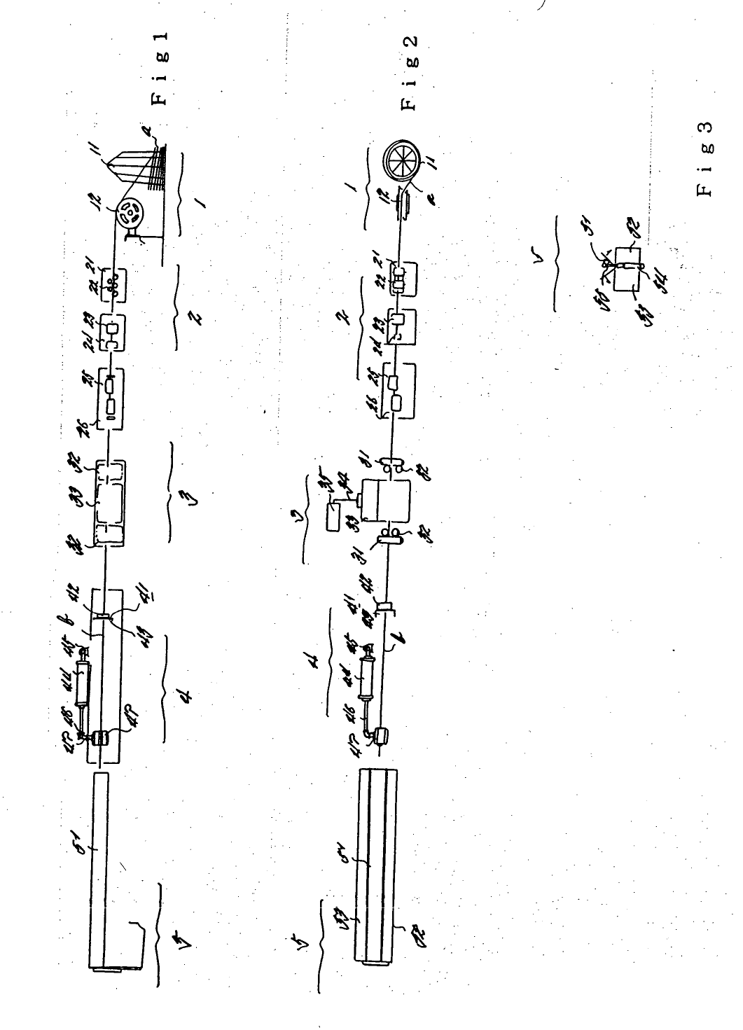

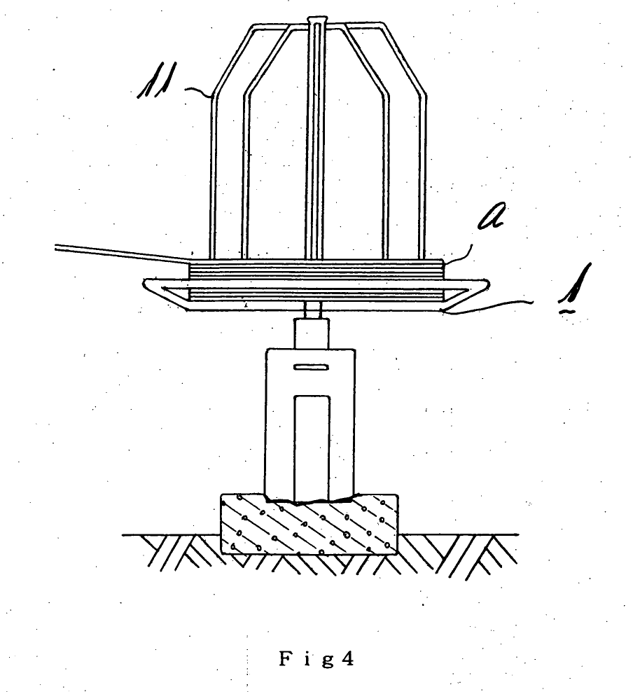

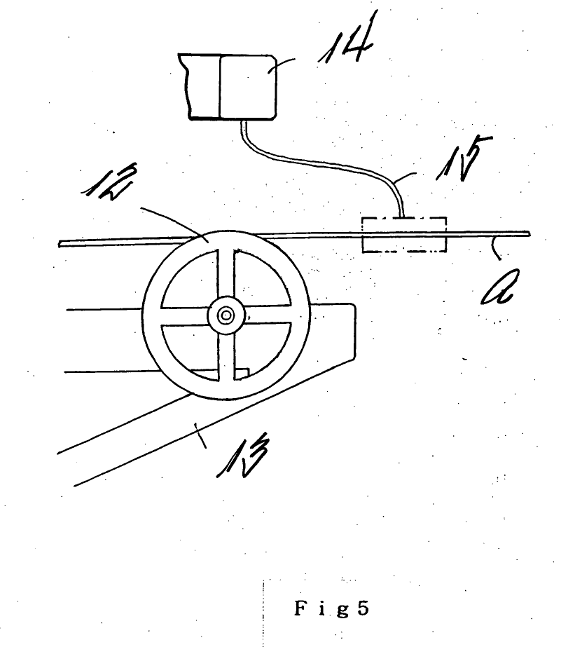

a Metallic wire rod
b Bar-like condition
1 Step of delivering the wire rod at a constant speed thereby to bring the wire rod into a linear condition (a bar)
2 Step of straightening the wire rod into a straight condition
3 Step of outputting and storing results
4 Step of delivering the cut wire rod to a mechanism for sorting the wire rod according to the quality of the wire rod
5 Sorting mechanism which performs rejection
11 Cage-like coiling bar having the a roughly conical shape
12 Delivery reel
13 Apparatus frame
14 Tank for a mixed flushing oil of a cutting oil and a lubricating oil
15 Piping
21 First straightening chamber
22 Center guide roller
23 Second straightening chamber
24 Roller
25 Third straightening chamber
26 Roller
31 Roller mechanism
32 Roller mechanism
33 Measurement mechanism
34 Signal
35 Computer system mechanism
41 Mechanism for the step of cutting the wire rod to prescribed lengths and sorting the wire rod
42 Cutting edge
43 Fixed edge
44 Transfer mechanism
45 Cylinder
46 Piston shaft
47 Chuck mechanism
51 V-shaped trough
52 Housing casing of conforming products
53 Housing casing of nonconforming products
54 Cylinder
55 Piston shaft

### DETAILED DESCRIPTION OF THE PREFERRED EMBODIMENTS

An embodiment of the present invention will be described by referring to the following drawings. All sections of a working and inspection system of a metallic wire rod of the present invention are arranged on the same line, and in a series of working processes of working a metallic wire rod (a) in a coiled condition to a wire rod which is under predetermined conditions, this system comprises: the step of delivering the coiled wire rod at a constant speed thereby to bring the wire rod into a linear condition (a bar) (1); the step of straightening the wire rod into a straight condition by causing the wire rod to pass through a straightening device in one or more places arranged in the direction of travel of the delivered wire rod (2); the step of causing the straightened wire rod to travel in a correct position, judging whether outside diameters and surface defects of the straightened wire rod are within preset prescribed allowances by detecting the outside diameters and surface defects, and outputting and storing results of the detection and judgment (3); and the step of cutting the wire rod in a traveling condition to preset predetermined lengths and delivering the cut wire rod to a mechanism for sorting the cut wire rod according to the quality of the cut wire rod (4). The working system has the sorting function of rejecting the delivered wire rod (bar) by output signals on the basis of judgment on whether the delivered wire rod has defects within the above-described tolerances (5).

In the step of delivering the wire rod (a) at a constant speed, there is provided a cage-like coiling bar having a roughly conical shape (11) and the wire rod (a) to be worked is coiled around this coiling bar in many folds.

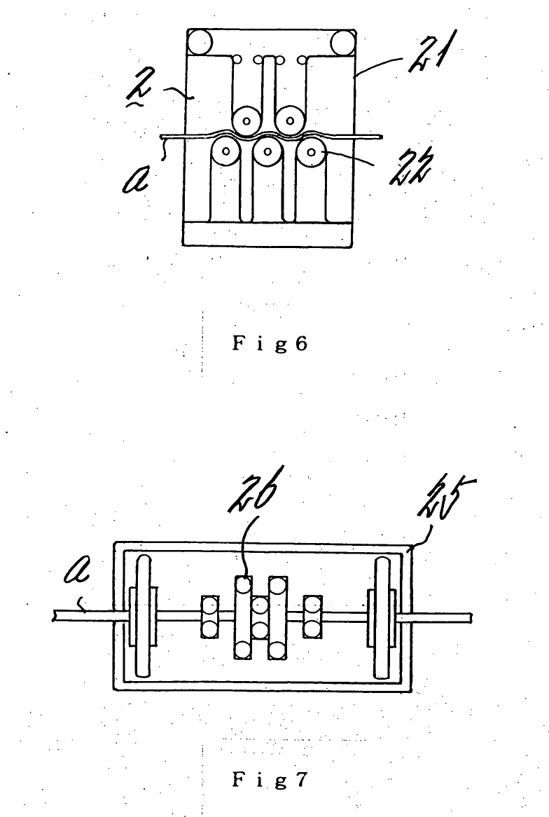

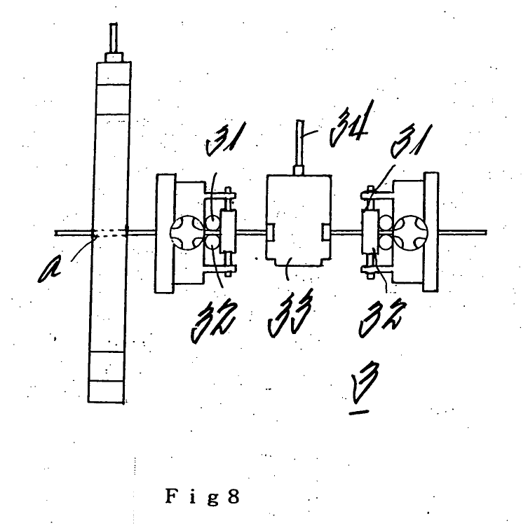

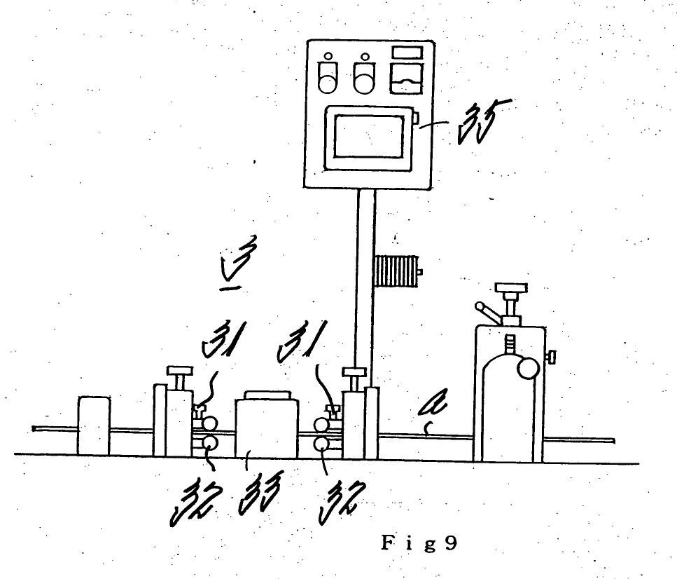

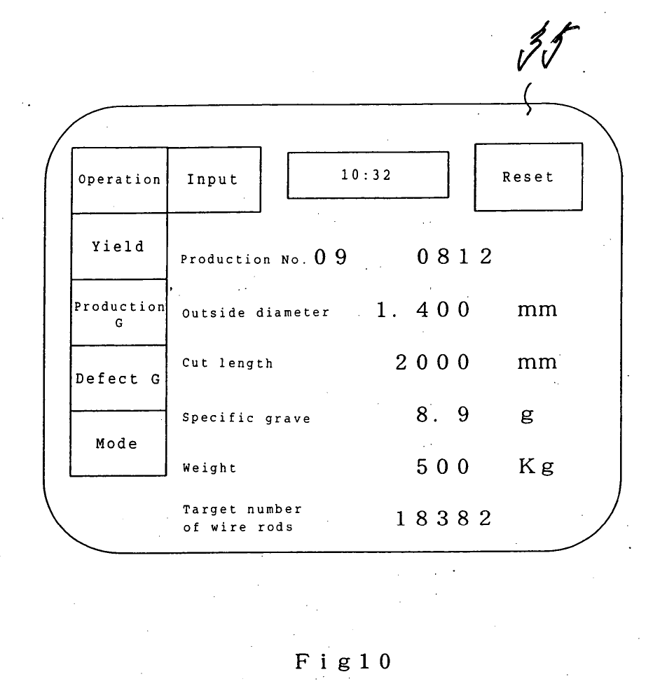

This coiled wire rod (a) is delivered by a delivery reel (12) provided at one end of an apparatus frame (13). In this case, in FIG. 5, the numeral 15 denotes a tank for a mixed flushing oil of a cutting oil and a lubricating oil, which is one of the features of the present invention, and after the receiving of this flushing oil supplied via piping (15), the coiled wire rod (a) is delivered by the reel (12).

In the figures, the numeral 2 denotes the straightening step of the wire rod (a), and in this step there are provided a center guide roller (22), which is disposed on a horizontal plane within a first straightening chamber (21) and can move in the direction of the axis line, and a roller (24), which is disposed within a second straightening chamber (23) and can move vertically. Furthermore, there are further a variety of rollers, for example, a roller (26), which is disposed in a third straightening chamber (25) and rotates around the wire rod. This step is provided to bring the wire rod (a) into a correct straight condition and for this purpose an optimum one is selected from various means. It is essential that a flushing oil be constantly supplied to the wire rod (a) in each of these straightening chambers from the above-described flushing oil tank (14) and that the straightening of the wire rod be performed in such an atmosphere.

In this case, within the third straightening chamber (25) there is provided laser measurement and inspection means which inspects the outside diameter (φ) of the wire rod (a) at the same time with or independently of the straightening action. For example, the tolerances for outside diameter errors when the present invention is carried out are 2 to 3 microns. When outside diameters outside the prescribed tolerances have been measured, the result of the measurement is output to succeeding steps so that the wire rod (a) in question is rejected as a nonconforming product whose outside diameter is outside the prescribed tolerances.

The reference numeral 33 denotes a measuring mechanism of the step of inspecting whether there are defects in the outside diameter and surface of the wire rod (a). Before and behind in the direction of travel of the wire rod (a), #-shaped roller mechanisms (31), (32) are arranged so that the wire rod (a) which is positioned in a measuring mechanism (33) can constantly keep a correct horizontal straight line.

As another inspection and measuring mechanism (33), in many cases there is also a measuring mechanism which measures the transfer amount of the wire rod (a) which is transferred. In such a case, there is provided a computer system mechanism (35), which controls the transfer amount of the wire rod (a) on the basis of detection values of surface defects of the wire rod (a) and length, i.e., transfer amount of the wire rod (a) and preset values and produces signals (34) to reject a nonconforming product by use of the means, which will be described later, when the nonconforming product contains defects exceeding the prescribed tolerances.

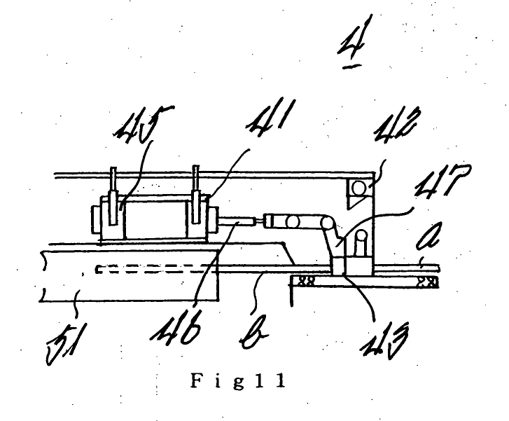

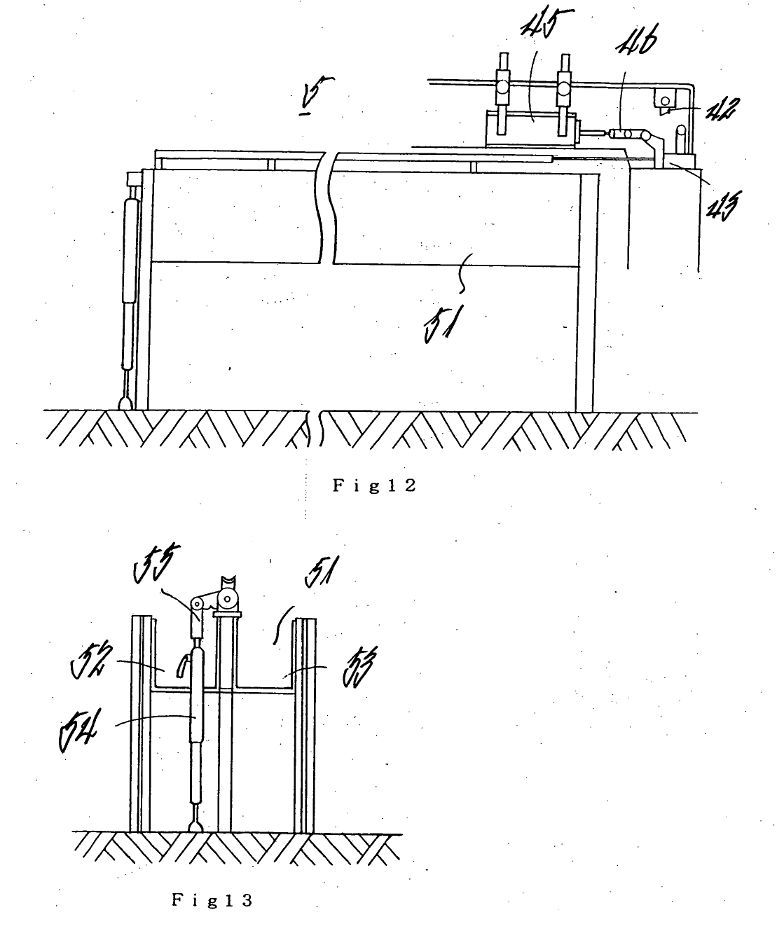

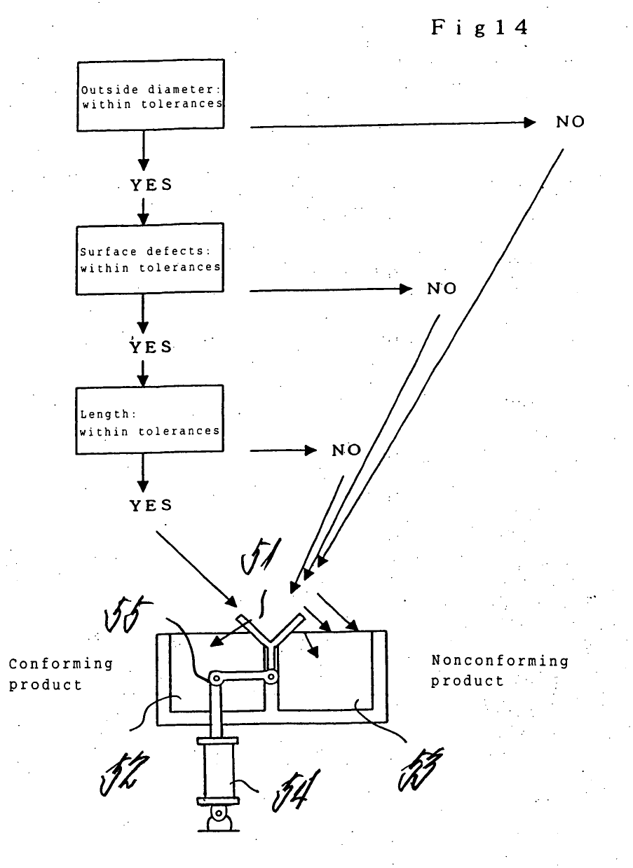

In this case, it is essential that this computer system mechanism (35) be programmed so that the computer system mechanism (35) can store the quantity of inspected conforming products and nonconforming products, the quantity of completed devices and all data and information in carrying out the present invention, and can give a graphic representation of such data and information and display manufacturing plans etc. (refer to FIG. 10) as required.

In the figures, the reference numeral 4 denotes a mechanism of the step of cutting the wire rod (a), (which has the shape of a bar), to prescribed lengths and performing sorting, and the numeral 41 denotes a cutting device of this step.

The reference numeral 42 denotes a cutting edge which can cut the wire rod in a sliding condition and the numeral 43 denotes a receiving fixed edge which cuts the wire rod (a) in engagement with this cutting edge (42).

The reference numeral 44 denotes a transfer mechanism which performs the transfer of the wire rod (a) (the bar (b)), and this transfer mechanism is a combination of a cylinder (45), which is fixed in a prescribed position or mounted on a pivot so as to be able perform a motion in the shape of a fan, and a piston shaft (46). The leading end of this piston shaft (46) is provided with a chuck mechanism (47) of the wire rod (a) (the bar (b)).

Although this chuck mechanism (47) is not described or illustrated in detail, any chuck mechanism may be used so long as the chuck mechanism can transfer the wire rod (a) (the bar (b)) from a prescribed position to a prescribed position while supporting the wire rod (a) (the bar (b)) by sandwiching it.

Although the transfer distance of the piston shaft (46) is variable, this distance is equal to the length of the wire rod (a) (the bar (b)) to be cut.

In the figures, the reference numeral 5 denotes a sorting mechanism, and this sorting mechanism has the function of sorting out conforming products from nonconforming products on the basis of a signal which indicates whether the above-described length and surface defects of the bar (b) delivered from the above-described cutting mechanism are within tolerances.

The sorting mechanism 51, which is a V-shaped trough which is aligned with the axis line of the bar (b) and has a length larger than the length of the cut bar (b), is rotationally mounted on a pivot on the apparatus frame, which is not shown. Although this rotation means may have any construction so long as the construction permits the rotation of the trough (51) either to the right or to the left on the basis of the above-described signal of inspection results which indicates whether the bar (b) is a conforming product or a nonconforming product, the rotation means may have a simple construction in which, for example, a piston shaft (55) of a cylinder (54) whose terminal end is supported on the apparatus frame is mounted on either of the edges of the trough (51).

The reference numerals 52, 53 denote housing casings which are just under the trough (51) and separated into two portions in the horizontal direction and have open tops.

The operation of the present invention will be briefly described by referring to FIG. 14. The wire rod (a) which has been coiled beforehand around the coiling frame (11) is guided out by use of various straightening rollers via the reel (12) in the direction of the group of the straightening rollers.

In this case, the flushing oil within the tank (14) is supplied via the piping (15) to the wire rod (a) by use of the means of spraying or application. Because in this case the flushing oil is a mixed oil of what is called a cutting oil and a lubricating oil, the front of the wire rod (a) becomes smooth, is a little polished and increases in luster, with the result that the presence of this lubricating oil promotes smooth sliding work and a smooth straightening operation for correcting bending strains.

The wire rod (a) is brought into an accurate straight condition by use of the various rollers (24), (26), the roller mechanisms (31), (32), etc. First, the outside diameter of the wire rod (a) is measured by a laser to determine whether the outside diameter is within present tolerances and at the same time or subsequently the wire rod (a) reaches the measuring mechanism (33), where calculations are performed to determine whether defects and cracks in the surface are within the tolerances of preset standard values.

When the wire rod (a) which has passed the above-described steps pass through the clearance between the cutting edge (42) and the fixed edge (43) opposed to this cutting edge, the leading end portion of the wire rod (a) is chucked by the chuck mechanism (47) provided on the piston shaft (46), and the wire rod (a) moves to the left side in the drawing, i.e., onto the above-described trough (51), with the chucked condition kept as it is.

This moving distance is stored beforehand by being presented to the piston shaft (46) of the cylinder (45) and when a predetermined moving distance is reached, the above-described cutting edge (42), along with the fixed edge, cuts the wire rod (a) while keeping this moving condition, and causes the wire rod (a) to fall onto the trough (51) of the sorting stage.

Simultaneously with this, when the above-described bar (b) is a conforming product (that is, when there is no problem in the outside diameter or defects on the outer surface), the signal is transmitted to the piston shaft (55) and the trough (51) is rotated counterclockwise so that the bar (b) is caused to fall in the direction of the housing casing for conforming products (52).

On the other hand, when the bar (b) which has been delivered is a nonconforming product, on the basis of the signal the trough (51) rotates clockwise and the bar (b) is caused to fall into the housing casing for nonconforming products (53), whereby the sorting and classification of the bar (b) is completed.

1. A working system of a metallic wire rod in a series of working processes of working a metallic wire rod (bar) in a coiled condition to a wire rod which is under predetermined conditions, comprising:
(1) the step of delivering the coiled wire rod at a constant speed thereby to bring the wire rod into a linear condition (a bar);
(2) the step of straightening the wire rod into a straight condition by causing the wire rod to pass through a straightening device in one or more places arranged in the direction of travel of the delivered wire rod;
(3) the step of causing the straightened wire rod to travel in a correct position, judging whether outside diameters and surface defects of the straightened wire rod are within preset prescribed allowances by detecting the outside diameters and surface defects, and outputting and storing results of the detection and judgment; and
(4) the step of cutting the wire rod in a traveling condition to preset predetermined lengths and delivering the cut wire rod to a mechanism for sorting the wire rod according to the quality of the wire rod;
wherein the working system has the sorting function of rejecting the delivered wire rod (bar) if the wire rod (bar) has defects outside the above tolerances for defects.

2. The working system of a metallic wire rod according to claim 1, wherein when the wire rod is caused to pass through a straightening device in one or more places during the travel of the wire rod, a flushing oil which is a mixed oil comprising a cutting oil and a lubricating oil is sprayed or applied to the wire rod.
